(19) United States
(12) Patent Application Publication
(10) Pub. No.: US 2026/0330460 A1
(43) Pub. Date: Oct. 22, 2026

(54) SECURE DIGITAL & TRADITIONAL TRANSACTIONS BASED ON LOCATION

(71) Applicant: Layth Mhammad Fahed AL HADIDI, Al Salt (JO)

(72) Inventor: Layth Mhammad Fahed AL HADIDI, Al Salt (JO)

(21) Appl. No.: 19/484,399

(22) PCT Filed: May 15, 2023
(86) PCT No.: PCT/IB2023/054967

§ 371 Date: Nov. 14, 2025

(51) Int. Cl. G06Q 20/40; G06Q 20/32; G06Q 20/38; G06Q 20/42; H04W 4/02

(52) U.S. Cl. CPC G06Q 20/40155; G06Q 20/3224; G06Q 20/3278; G06Q 20/3821; G06Q 20/403; G06Q 20/405; G06Q 20/42; H04W 4/023

(57) ABSTRACT

The system built up to secure transactions for customers by comparing the locations of the customers and where the transactions done. This done by tracking customer locations through GPS in the device that had the applications, and customers entered its personal data such as its cards data or linked our system with his/her bank accounts, our system will provide the processer or acquirer with the approval code, and will integrate with banks system to validate any financial transactions through the banks application or branches based on the locations.

### FIELD OF THE INVENTION

The present invention related generally to a system and methods for protecting transactions financially and non-financially for the customers that done the transactions through traditional way (Cards & branches) and digitals (payment applications, online, website) or any other path.

### BACKGROUND OF THE INVENTION

The rise of the digital payments started in the early 90s until now. we have reached the point where it's hard to imagine world in which digital payment does not exist. As switching from cash base (physical) to digital transaction payment which offered level of speed, safety, convenience and efficiency for the customers.

The Stanford Federal Credit Union is the first organization that offer to their clients an online payment system done in 1994. In 1998, PayPal was founded, its considered to be one of the first companies to specialize in online payment system. According to Statista, there were 950 million mobile payment transactions worldwide in 2019. This number is expected to climb to 1.3 billion users by 2023. The increasing in digital payment rise the risk of fraud transactions and hacking accounts data and balances.

### SUMMARY OF THE INVENTION

The system will match the location of the transaction with the location of the beneficiary. The user will do some steps to secure any transactions which include downloading the application on the mobile, tablet, laptop, notebook, personal digital assistants (PDAs), or any other device known in the art. After the user should create his own account by entering his cards data and related personal information, and he need to choose the priority for cards, and determine the ceiling for transactions that he will allow them to pass without password and type of these transactions based on his/her lifestyle. When the customer create an account, the application should have the access for the location feature must be permanent activated so the accessibility will be all the time. System will track the device location and when any transactions done, the system will match the two locations (the customer device “who do the transaction” and the merchant “the receiver of the payment ”), if both locations match the transaction will be passed by sending approval code to processer or acquirer . the system provide protection for several cards at the same time from any unauthorized transactions and its protect customers from using their data in issuing new cards or opening accounts or in any fraud by verifying customer location and notifying the customer to tack his/her confirmation and approval (this depend on the path used for the transactions and banks, processers, acquirers connected).

### DESCRIPTION OF THE DRAWINGS

FIG 1

Showed how should devices for customer (Laptop “101”, Smart phone “102”, PC “103”, Tablet “104”) be connected with internet “105” to create account in our application “system 106” and enter his/her personal data that need to be secured from unauthorized used by other. And by connecting with internet and allowed tour application to access to their locations we can secure their data.

FIG. 2

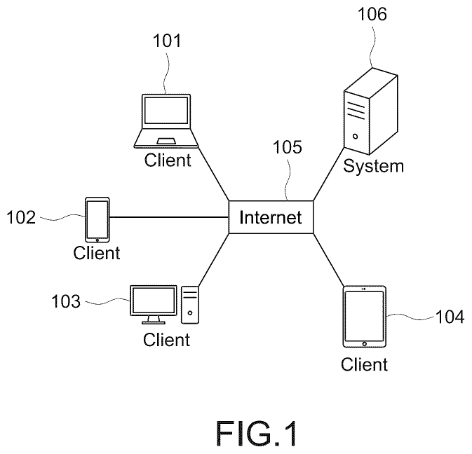

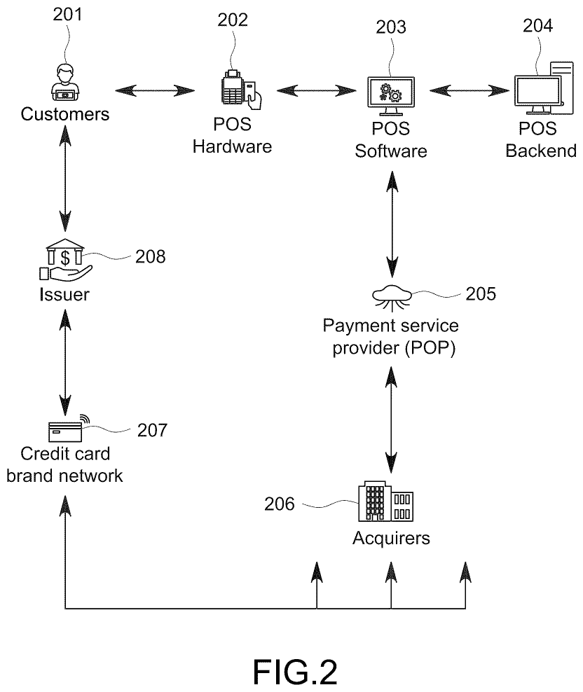

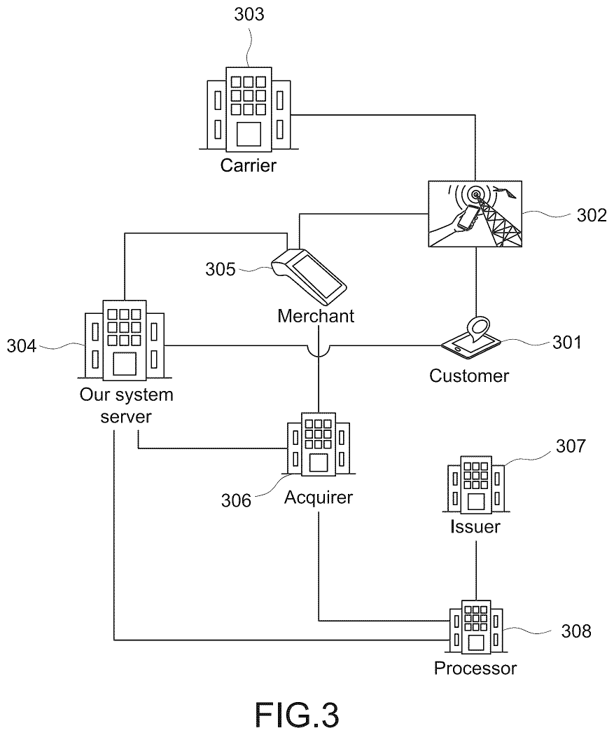

Showed the flow for the digital payment through the cards or mobile into the merchant. The customer “201” should has an account with the issuer “208” which this issuer should have approval from credit cards brand network scheme “207” to issue cards (plastic card or virtual card), the customer “201” paid through cards presented or virtual cards (mobile, tablet or watch) to the merchant through the POS machine “202” that send the customer data in POS software “203” these data will be encrypted and it will read by the POS backend “204” and will shared with the acquirer “206” by PSP “205”, then the acquirer will send to the processer (scheme 207) at the end the data will send to the issuer that will check the data like if there are sufficient fund in customer and the card are active the transaction will be approved and then the approval code will be send so in the end the transaction will be done and the merchant will be receive the receipt for acceptance.

FIG. 3

Show that customer “301” and POS machine (merchant “305”) should be connected to internet “302” with carrier (telecom company “303”) and customer “301” should has account in our application “304” and allowed our application to access to his/her location all time and merchant “305” can connect to our application direct or through the acquirer “306” so our system can match the two locations and send the approval code to issuer “307” or processer “308” and the normal process that the information about the transaction send from the merchant “305” to the acquirer “306” and after the acquirer send the transaction information to the processer “308” which will share them with the issuer “307” and the issuer will approved the transaction based on many criteria (approval code that send by us, customer balance, cards status and many other)

### DETAILED DESCRIPTION OF THE INVENTION

The system will secure the transactions (financially and non-financially) for the customers based on comparing the location of the customer (that had the application) and the location of the transaction that had been done. The access for the location of the customer should be always activated so that the system will track the and record the movement of the device that has the application which will be with the customer to understand the customer behavioral and approved the transaction based on matching the two location mainly or through the system mechanism of coding (encrypt the transaction) and verification. The transactions can be done through several paths and ways as below:
1—Payment through cards, if its debit or credit cards (cards presented): The current process for the payment through cards presenting is that the merchant enter the amount of the transaction into the Point of sale machine (202) and asked the customer for the cards and then the cards entered into the POS or through the contactless feature the transaction will go through payment service provider (205) then to acquirer (206) and then it sent the transaction to the processer (206) (some time the processer and the acquirer are same) and to the schemes or processer (207) approved the transaction with the issuers (208) of the cards if it didn't match with one of fraud system criteria it will be approved main while the fraud system read customer history transactions and build up a base can expect customer behavioral . but it accept the transaction in general role the new system will add condition that match the location for the transaction (merchant (305)) and the owner of the cards (or card holder (301)). By download the application (304) and activate the access to your location (302) as customer ((301) card holder) and put the data for your cards through the application the system (303) will encrypt the data for the cards and your personal data. There are more one process will be add to current process which send to bank (307) or processer (308) that when cards define into the system (304) we communicate with bank owner ((307) the issuer of the cards) and inform them that we have this card under our security system and we will integrate with the bank ((307) or processer (308) so if any transaction done on the cards the bank (307) or the processer (308) will add new rule that if the cards identify through the system it will send to us the transactions details through secured encrypt system and line so the system (304) will read the details of the transactions and it will match the location for the merchant (305) and the owner or holder of the card, if both locations matched the system will send the approval code so the transaction will accept.
2—Payment through the program on the mobile or tablet or virtual card: the current (one of them) process is based on input the data related to cards and the owner (201) that will be encrypted (code) and encrypted code will share with bank (card issuer (208) ) or processer (207) so transactions done in any merchant (POS) as the merchant (202) enter amount of the transaction and then the cards holder use his phone (101), tablet (104) or watch to approve the transaction through sharing encrypted code for cards that will read be POS machine (202) and send it to the acquirer (206) then will sent to processer (207) and at the end to card issuer (208) or E-wallet manager to be approved if there is sufficient fund and active account . what will enhance by our system that the transaction before its approved it will be checked if this card data recorded in our database (which will be shared or linked with all issuer the list of their cards secured by our system (304)) the transaction will pass after match the location of the device that had the application (301) with merchant (305) location if both matched, transaction will approved, not will be rejected. if the cards not recorded in our system, it will pass based on issuer rule (307). and the customer (301) will be informed if any transaction done on his/her account without matching the location so he can deactivate his account.
3—Websites digital payment (E-commerce)
The payment process done through two methods:
   A—Through device that had the application.
   when a customer done online transaction through website or application the gateway (205) that manage the payment for the website or application the gateway (205) will send the transactions details for the processer (207) to approve the transaction and the processer (207) will verify the transaction with the issuer (208) and if there are sufficient fund in the owner of the account ((201) payer) the transaction will approve and the customer (201) will notify. the enhancement will be in two ways the first one that the transaction done through the device (301) that had our application so that they have the same IP address (301) and carrier (303) details so our system (304) will compare the two IP address for the device, if they match the transaction will be approved, the second way that our system (304) will be integrated with gateway (306) so this will check and approved the transaction base on the fingerprint or password or face recognition (based on customer rule that put in our application), and we can used the both way together.
   B—Through the device that did not have our application.
   when the details of the device that the transaction done through it didn't match with data of the device (301) that recorded into the system then the system will send confirmation notification to the customer so if he/she approve the transaction through the system by entering the password or fingerprint or face recognition then the system will send the approval code to the bank issuer (307) or processer (308) to accept the payment. this process if the customer (301) has account in our application to secure his/her cards and accounts.
   if the transaction done through device that didn't had our application, but the device had NFC or Bluetooth, so when the payment done and the gateway (306) are integrated with our system (304), the customer (301) can choose to pay through our system so the customer (301) will not need to enter the data for the cards so we will reduce the risk of hacking customer data and using them in fraud transactions. when the payment done by using our system (304) as payment method new window will be open for our payment website so the customer (301) will have option to choose NFC or Bluetooth after choosing one of them the code will be sending through the chosen method and it will be reader by our application on the customer (301) device and send the conformation code that contain our encrypted customer data (this code include location, time, carrier data, cards encrypt data) and this code will go to gateway (306) and read by our system and confirm the transaction.
4—Integrate system with POS system and banks system: our system (304) will integrate with the acquirer (306) and issuer (307) platform so this will enable our system (304) to use the coding and encrypting mechanism which will be based on changing the coding for POS machine (305) and transactions code. POS (305) will be changed its ID frequently based on strong algorithm that contain the acquirer (306) code with POS (305) code and location code, this will be sent with every transaction done and the processer (308) and issuer (307) will read the transactions details and our system (304) that integrated with them will read the transaction details and match them with the location of the payer ((301) the location for the payer (301) will locate by the application of the bank (307) or the carrier (303) or our application (304) or the gateway (306)) this need form the payer (customer (301)) to give the access to his/her location all the time so our system (304) can match the location (302) of the transaction and the customer (301) in order to approve transaction. if the location (302) for the payer (customer (301) ) can't be identified, POS (305) machine or gateway (306) will communicate with device of the customer (301) through Bluetooth or NFC to approve the transaction through our rules that approved transaction through saved code for certain limit that identify by the customer (301) and also can be confirm by the customer (301) through confirmation on the notification that will send through NFC or Bluetooth.
5—System as verification tools for transactions
System (304) will be used as verification tools by calculating distance between two transactions for same customer (301) and time between them to make sure that it done by the customer (301). this process will be done by calculating the distance between two merchants (305) through the data we have about the location of each of merchant (305) and the time need to arrive from merchant A to merchant B. we first need integrated with Google Maps or any other applications to provide us with average time for arriving between the two merchants. and after we can build up our time by calculating the history for old transactions and its time and customers behavioral.
6—Integrated system with transporting applications and automobile system System (304) will be integrated with transporting applications like Upper or others by transferring data about trip when cards used in payment like trip data “ starting point & ending points ”this will help the system (304) to verification transactions based on data collected and even for offline transactions. System (304) will be integrated with automobile system to interchange location (302) data and trip data that can help the system (304) to verification transactions based on data collected about locations and even for offline transactions.
7—Integrated the system with the carrier
system (304) can be integrated with the carrier (303) so the location (302) can be located even without internet this will after taking the conformation from the customer (301) . the location (302) will be provided by the carrier (303) and our system (304) will record the customer (301) locations to build history for the customer (301) to use it in approving the transaction done by the customer (301) and understand the customer (301) behavioral that will help us in reducing the risk from any fraud transactions.

### NOTES

we can use several option from above together or all of them to secure transaction done by the customers.
the system will trace the movement for the customer to build the behavioral of the customer to use them in predicting the fraud transaction and protecting customer data to be used in non-authorized transactions.
when the customer create profile though the application and enter his/her data, these data will use in securing customer data to be used without his/her approval by integrating with financial institution so when any customer open account and our system are integrated with them so checking and matching the customer location to approve the transaction and inform him/her if there are any transaction done when two location not match to take his/her approval to process the transaction.

1. A system for facilitating secure digital transactions using location, the system comprising:
one or more customer devices, each associated with a payer, registered with the system;
one or more acquirer devices, each associated with a receiver, registered with the system;
a processing server associated with the payment application and connected with the one or more customer devices and one or more acquirer devices running the payment application over a communication network, the processing server comprising:
a memory unit configured to store machine-readable instructions; and
a processor operably connected with the memory unit, the processor obtaining the machine-readable instructions from the memory unit, and being configured by the machine-readable instructions to:
receive a request for a payment to be received from an acquirer device of the one or more acquirer devices;
obtain a location of the acquirer device making the request;
receive payment credentials of the payer associated with a customer device of the one or more customer devices, to make the payment;
obtain a location of the customer device making the payment;
confirm authenticity of the payment credentials and availability of funds to make the payment; and
facilitate the transaction only if the location of the acquirer device matches the location of the customer device making the payment, otherwise the transaction is declined, thereby eliminating possibility of any fraud.

2. The system as claimed in claim 1, wherein the one or more customer devices are selected from a group comprising mobile, smartphone, a laptop, a desktop and Personal Digital Assistant (PDA), having computing capabilities;
wherein the one or more customer devices include one or more of inbuilt or externally connected GPS module, NFC, RFID tag, internet module for obtaining the location of the respective customer device, enabling contactless payments and facilitating wireless connectivity with other devices, payment escrows as well as banking servers.

3. The system as claimed in claim 2, wherein the one or more customer devices are envisaged to include prestored details of the payment modes to be used for payments selected from Credit cards, debit cards, internet banking, virtual cards, and digital wallets.

4. The system as claimed in claim 3, wherein the prestored details include one or more of cards numbers, expiry date, password, card holder, banking ID, registered numbers and usernames for digital wallets as profile account by the respective customers to be used in verification for any transaction.

5. The system as claimed in claim 1, wherein the one or more acquirer devices are selected from Point of Sales (POS) terminals, mobiles, smartphones, tablets, PDAs, desktop computers, and laptops;
wherein the one or more acquirer devices include one or more of inbuilt or externally connected GPS module, NFC, RFID tag, internet module for obtaining the location of the respective customer device, enabling contactless payments and facilitating wireless connectivity with other devices, payment escrows as well as banking servers.

6. The system as claimed in claim 1, wherein the one or more acquirer devices are configured to obtain location from inbuilt or externally connected GPS module, or from communication network.

7. The system as claimed in claim 1, wherein the one or more acquirer devices are configured to send a code indicative of location of acquirer device, transaction ID, a date & a time of transaction, which is read by the processor for verifying the transaction.

8. The system as claimed in claim 1, wherein for facilitating the transactions on the customer device or the acquirer device not running the payment application, the processor is configured to verify if both the customer device and the acquirer device are connected to same internet portal using MAC address and then the payment application will integrate IP address or MAC address through its approval logarithm code and when both match the system, and accordingly the approval is sent.

9. The system as claimed in claim 1, wherein the processor is further configured to generate and send a confirmation or approval code once the location is matched, to the customer device, and which then needs to be entered by the customer device to facilitate the transaction.

10. The system as claimed in claim 1, wherein the processor is further configured to facilitate transaction in absence of internet connectivity by using predefined offline codes indicative of location, transaction ID, a date & a time of transaction.

11. The system as claimed in claim 1, wherein, for verification, the processor is further configured to consider a time between two transactions and a distance between the two locations for the two acquirers, and calculating a possibility of travelling determined distance in determined time, for considering authenticity of the transaction to prevent any fraud.

12. The system as claimed in claim 1, wherein the processor is configured to facilitate a predetermined number of transactions per day or per payment mode.

13. The system as claimed in claim 1, wherein the processor is configured to facilitate a predetermined payment amount in transactions per day or per payment mode, to limit fraudulent transactions in case the customer device is lost.

14. The system as claimed in claim 1, wherein the one or more acquirer devices include an inbuilt or externally connected NFC module;
wherein the processing module is configured to generate an approval code indicative of location, transaction code, date & time, and the send the same to the device involved in the transaction;
wherein the NFC module is configured to read the approval code from the customer device or the approval code is manually entered in to the payment application;
wherein the processing module is configured to process the received approval code to collect the location, transaction code, date & time embedded in the approval code to confirm the correctness of the approval code before allowing and facilitating the transaction.

15. The system as claimed in claim 1, wherein the payment application on the customer device is integrated with a transporting application to:
interchange trip data of the customer device between old location and new location, and a distance therebetween, using a GPS between where second transaction is being requested;
calculate the time needed to arrive at the second location from old location, and provide the same to the processing module to verify authenticity of the transactions.

16. The system as claimed in claim 1, wherein the payment application on the customer device is integrated with a mapping application to calculate distance between the two merchants and time between the transaction;
wherein the processing module is configured to verify a possibility of travelling the determined distance between two places within the said time, using the mapping application, before allowing and facilitating the transaction.

17. A computer-implemented method for facilitating secure digital transactions using location, the computer-implemented method comprising:
receiving a request for a payment to be received from an acquirer device of the one or more acquirer devices associated with receivers;
obtaining a location of the acquirer device making the request;
receiving payment credentials of the payer associated with a customer device of the one or more customer devices, to make the payment;
obtaining a location of the customer device making the payment;
confirming authenticity of the payment credentials and availability of funds to make the payment; and
facilitating the transaction only if the location of the acquirer device matches the location of the customer device making the payment, otherwise the transaction is declined, thereby eliminating possibility of any fraud.

18. The computer-implemented method as claimed in claim 14, wherein the one or more customer devices are selected from a group comprising mobile, smartphone, a laptop, a desktop and Personal Digital Assistant (PDA), having computing capabilities;
wherein the one or more customer devices include one or more of inbuilt or externally connected GPS module, NFC, RFID tag, internet module for obtaining the location of the respective customer device, enabling contactless payments and facilitating wireless connectivity with other devices, payment escrows as well as banking servers.

19. The computer-implemented method as claimed in claim 15, wherein the one or more customer devices are envisaged to include prestored details of the payment modes to be used for payments selected from Credit cards, debit cards, internet banking, virtual cards, and digital wallets.

20. The computer-implemented method as claimed in claim 16, wherein the prestored details include one or more of cards numbers, expiry date, password, card holder, banking ID, registered numbers and usernames for digital wallets as profile account by the respective customers to be used in verification for any transaction.

21. The computer-implemented method as claimed in claim 14, wherein the one or more acquirer devices are selected from Point of Sales (POS) terminals, mobiles, smartphones, tablets, PDAs, desktop computers, and laptops;
wherein the one or more acquirer devices include one or more of inbuilt or externally connected GPS module, NFC, RFID tag, internet module for obtaining the location of the respective customer device, enabling contactless payments and facilitating wireless connectivity with other devices, payment escrows as well as banking servers.

22. The computer-implemented method as claimed in claim 14, wherein the step of obtaining location of the one or more acquirer devices include obtaining location from inbuilt or externally connected GPS module, or from communication network.

23. The computer-implemented method as claimed in claim 14, further comprising a step of receiving a code from the one or more acquirer devices, the code indicative of a location of acquirer device, transaction ID, a date & a time of transaction, which is read by the processor for verifying the transaction.

24. The computer-implemented method as claimed in claim 14, wherein the step of facilitating the transactions on the customer device or the acquirer device, not running the payment application, further comprising verifying if both the customer device and the acquirer device are connected to same internet portal using MAC address and then the payment application will integrate IP address or MAC address through its approval logarithm code and when both match the computer-implemented method, and accordingly the approval is sent.

25. The computer-implemented method as claimed in claim 14, further comprising a step of generating and sending a confirmation or approval code once the location is matched, to the customer device, and which then needs to be entered by the customer device to facilitate the transaction.

26. The computer-implemented method as claimed in claim 14, further comprising a step of facilitating transaction in absence of internet connectivity by using predefined offline codes indicative of location, transaction ID, a date & a time of transaction.

27. The computer-implemented method as claimed in claim 14, further comprising a step of taking into consideration, a time between two transactions and a distance between the two locations for the two acquirers, and calculating a possibility of travelling determined distance in determined time, for considering authenticity of the transaction to prevent any fraud.

28. The computer-implemented method as claimed in claim 14, further comprising a step of facilitating a predetermined number of transactions per day or per payment mode.

29. The computer-implemented method as claimed in claim 14, further comprising a step of facilitating a predetermined payment amount in transactions per day or per payment mode, to limit fraudulent transactions in case the customer device is lost.
